(19) United States
(12) Patent Application Publication
(10) Pub. No.: US 2022/0247617 A1
(43) Pub. Date: Aug. 4, 2022

(54) FLEXIBLE PIPELINE PROCESSING METHOD AND SYSTEM

(71) Applicant: NOVIFLOW INC., Montréal (CA)

(72) Inventor: CARON-AUGER Pierre-Louis, Montreal (CA)

(21) Appl. No.: 17/594,738

(22) PCT Filed: Apr. 29, 2020
(86) PCT No.: PCT/CA2020/050563

§ 371 Date: Oct. 28, 2021

Related U.S. Application Data
(60) Provisional application No. 62/840,058, filed on Apr. 29, 2019.

(51) Int. Cl. H04L 41/045; H04L 45/76; G06F 9/445

(52) U.S. Cl. CPC H04L 41/045; G06F 9/44505; H04L 45/76

(57) ABSTRACT

A reprogrammable software defined network device is disclosed which allows at any time the selection of a desired subset of features from all possible features, without the requirement of making available all possible features that might otherwise be programmed into the programmable switch, and without the requirement of reprogramming the interface which is used to access the features. The device comprises a standardized control API and a programmable switch capable of implementing only a subset of said plurality of switch features, each accessible via a runtime API and a control library interconnecting the control API and the runtime API such that each of the subset is accessible by the external controller using said standardized control API via said runtime API. The subset changes from time to time in response user requirements. A change in the subset of features gives tise to a change in the runtime API.

### FIELD OF THE INVENTION

The present invention relates to a flexible pipeline processing system and method.

### BACKGROUND TO THE INVENTION

Software-Defined Networking (SDN) is a network architecture where network control is decoupled from forwarding of data packets and is directly programmable. That is, in SDN the control plane is separated from the data plane and such that what traditionally is a distributed process can be logically centralized. The control plane is programmable which enables modification and deployment of applications and control over flow-level traffic. This provides mechanism for shaping traffic in real time and depending on current needs.

The control plane consists of a controller and applications and the data plane consists of programmable devices/switches which forward packets dependent on their programming. The control plane makes decisions about where data traffic is to be sent whereas the data plane forwards the data traffic according to the decisions of the control.

A typical data plane is comprised of switches which forward data traffic such as packets according to control logic. Each switch may comprise one or more specialised data forwarding processors or the like, which forward the data traffic according to the control logic and in accordance with inputs received from the control plane. In a particular embodiment the data forwarding processors and their control logic may be programmable and such that a given switch may be customised to provide a particular type of data forwarding in a particular environment. One drawback of existing SDN networks is that, due to their finite nature, the programmable data forwarding processors are only customisable during programming with a limited subset of all possible features. Additionally, when reprogrammed with a different subset of features, the API which is used to access the features also changes, requiring changes in the way the features are accessed.

What is needed therefore, and an object of the present invention, is a method and system which allows at any time the selection of a desired subset of features from all possible features, without the requirement of making available all possible features that might otherwise be programmed into the programmable switch, and without the requirement of reprogramming the interface which is used to access the features.

### SUMMARY OF THE INVENTION

In order to address the above and other drawbacks there is provided a reprogram mable software defined network device for use with an external control application. The device comprises a standardized control API accessible by the external control application for accessing a plurality of switch features, a programmable switch capable of implementing only a subset of the plurality of switch features, a switch program for implementing the subset of the switch features on the programmable switch, each of the subset accessible via a runtime API, and a control library interconnecting the standardized control API and the runtime API such that each of the subset is accessible by the external controller using the standardized control API via the runtime API. The subset changes from time to time in response user requirements and wherein a change in the subset gives rise to a change in the runtime API.

There is also provided a method of providing via a standardized control API access to a selected subset of a plurality of possible features on a software defined network device comprising a programmable switch capable of implementing only the subset of the features at any one time. The method comprises recompiling a switch program to provide selected features from the plurality of features, wherein the selected features are accessible via a run time API, and recompiling a control library interconnecting the standardized control API and the run time API such that the selected features are accessible via the standardized control API.

Additionally, there is provided a method of recommissioning a software defined network device comprising a programmable switch capable of implementing only a subset of a plurality of possible features at any one time. The method comprises providing a standardized control API access to a first selected subset of a plurality of possible features on a software defined network device comprising a programmable switch capable of implementing only the subset of the features at any one time, recompiling a switch program to provide selected features from the plurality of features, wherein the selected features are accessible via a run time API, and recompiling a control library interconnecting the standardized control API and the run time API such that the selected features are accessible via the standardized control API.

There is additionally provided a method for optimising a network device comprising a plurality of processing pipelines operating in parallel for processing respective streams of data packets, each pipeline comprising a respective pipeline flow entry. The method comprises dividing each pipeline flow entry into a plurality of action steps each defining an ordered sequence of at least one action to be applied to the respective stream of data packets, each action step resulting in a step output, resolving each action step into and ordered series of action chains, each action chain comprising a subsequence of at least two dependent ones of the actions, and processing each data packet according to said ordered series of action chains.

Also, there is provided a data communications system for interconnecting at least one client application with at least one server application. The system comprises a control application, a plurality of reprogrammable software defined network (SDN) devices, one of the SDN devices connected to the at least one client application and a different one of the SDN devices connected to the at last one server application and wherein the SDN devices are interconnectable such that a data path and such that the at least one client application can communicate with a selected one of the at least one server application. Each of the SDN devices comprises a standardized control API accessible by the external control application for accessing a plurality of switch features, a programmable switch capable of implementing only a subset of the plurality of switch features, a switch program for implementing the subset of the switch features on the programmable switch, each of the subset accessible via a runtime API, and a control library interconnecting the standardized control API and the runtime API such that each of the subset is accessible by the external controller using the standardized control API via the runtime API. The subset changes from time to time in response user requirements and wherein a change in the subset gives rise to a change in the runtime API.

### BRIEF DESCRIPTION OF THE DRAWINGS

FIG. 1 provides a schematic diagram of a flexible pipeline processing system in accordance with an illustrative embodiment of the present invention;

FIG. 2A provides a schematic diagram of a network device in accordance with an illustrative embodiment of the present invention;

FIG. 2B provides a plan view of a flow table in accordance with an illustrative embodiment of the present invention;

FIG. 3A provides a schematic diagram of a pipeline processor in accordance with an illustrative embodiment of the present invention;

FIG. 3B provides a schematic diagram of an action chain in accordance with an illustrative embodiment of the present invention;

FIG. 4 provides a flow chart of an action chain optimisation method in accordance with an illustrative embodiment of the present invention;

FIG. 5A provides a schematic view of match table in accordance with an illustrative embodiment of the present invention;

FIG. 5B provides a schematic view of an action table in accordance with an illustrative embodiment of the present invention; and

FIG. 5C provides a schematic view of packet of data in accordance with an illustrative embodiment of the present invention.

### DETAILED DESCRIPTION OF THE ILLUSTRATIVE EMBODIMENTS

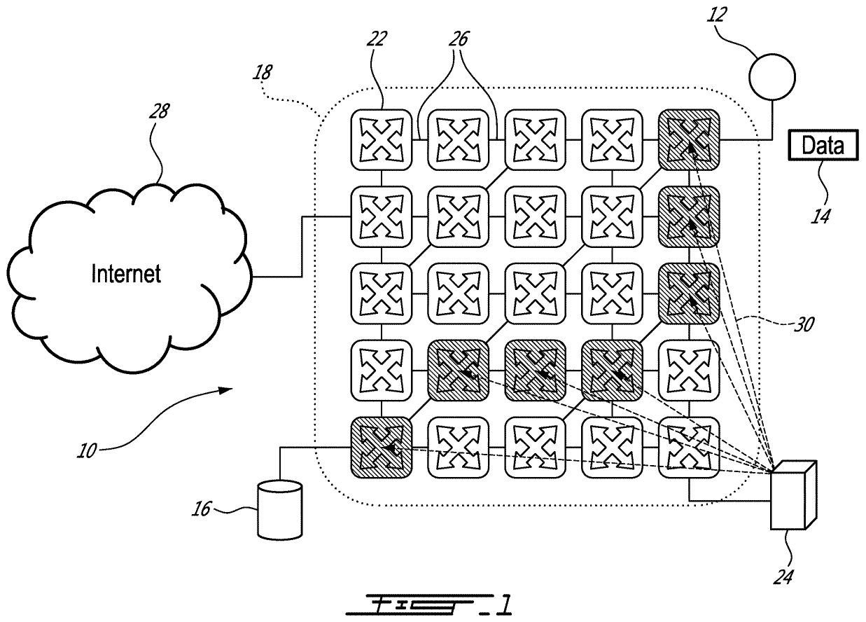

Referring now to FIG. 1, a flexible pipeline system, generally referred to using the reference numeral 10, will now be described. The system 10 illustratively comprises one or more clients 12 wishing to exchange data 14 with one or more servers 16 via a network 18 comprised of a plurality of software defined network devices 22. A controller 24 is also provided. The client(s) 12, server(s) 16 and network devices 22 are interconnected via number data links 26 and such that the client(s) 12, server(s) 16 and network devices 22 can communicate with one another and such that the data 14 is transferred between client 12 and server 16. In a particular embodiment, access may provided to an external network 28, such as the Internet, via one or more of the network devices 22.

The controller 24 communicates with the network devices 22 via a control channel 30 for the exchange of control information (not shown). Control information includes, for example, directives as to how data 14 should be handled, when data 14 arrives at one or other of the network devices 22, whether a data link 26 is up or down, and statistics such as the amount of data 14 received or sent by a given network device 22. In this manner decisions as to where the data 14 is to be sent (the controller 24) is decoupled from the underlying infrastructure that forwards the data 14 between its source and destination (network devices 22 and data links 24).

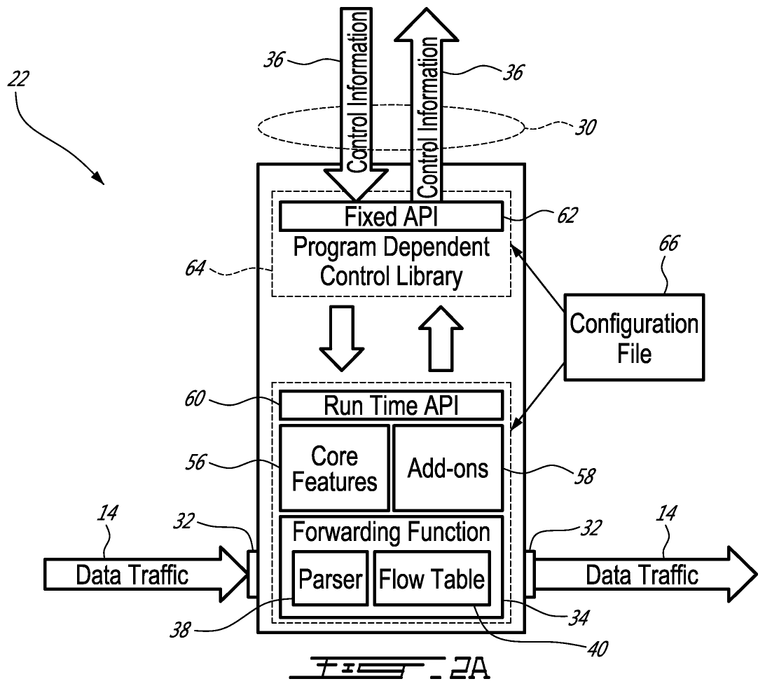

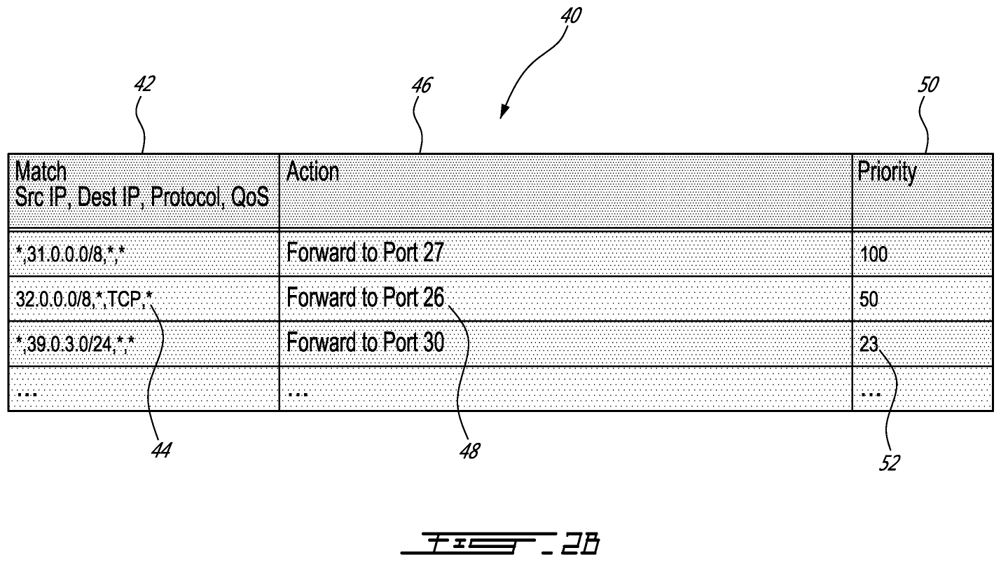

Referring now to FIG. 2A in addition to FIG. 1, each network device 22 comprises a plurality of ports 32 via which data 14 is received/sent and a forwarding function 34 which transfers received data 14 between ports 32. Control information 36 is exchanged with the controller 24 via the control channel 30 and may comprise, inter alia, information for controlling the forwarding function 34 and such that, for example, the network device 22 may act in concert with other network devices 22 to provide a path for data 14 to be transferred between the client 12 and server 16. A person of ordinary skill in the art will understand that the controller 24 of the illustrative embodiment is centralized allowing data traffic within the network to be controlled deterministically, but may also be distributed, for example attached to the switch it controls.

Still referring to FIG. 2A, in a particular embodiment the forwarding function 34 may comprise a parser 38 for examining the headers of data 14 in the form of packets received at one of the ports and a flow table 40 which dictates how the packet is to be forwarded. Referring to FIG. 2B in addition to FIG. 2A, each flow table 40 illustratively comprises a plurality of entries each comprising a match field 42 comprising one or more attributes 44, which is compared to the parsed header of a received data packet, and an action field 46 comprising an action 48 which is applied to the data packet on a match of the parsed header to the match field 42. A priority field 50 comprising a priority level 52 may also be provided in order to address data packets to which more than one entry applies. Other fields, such as the duration or time period that a given flow table entry is active (not shown), may also be provided.

Still referring to FIG. 2B in addition to FIG. 2A, the attributes 44 which make up the match field 42 may include specific or ranges of source and/or destination addresses, protocol types, required Quality of Service (QoS), or the like. Actions 48 may include, for example, forwarding the data 14 to a particular port 28, deleting the data 14, requesting the controller 24 via the control channel 30 to provide control information 36 on how to handle the data 14, etc. Control information 36 received from the controller 24 on the action to take respective data 14 is typically cached and such that subsequent similar data 14 received at the network device 22 can be handled without requiring additional control information 54 from the controller 24. In many cases the flow table 40 comprises sufficient entries to handle incoming data 14 without requesting additional control information 54 from the controller 24.

Referring back to FIG. 2A, in a particular embodiment the network device comprises a plurality of core features 56 which are available in all network devices 22 and a plurality of user configurable add-on features 58. Core features 56 would typically be provided that dictate the flow of data 14 via the forwarding function. Configurable features include inter alia the quantity and size of match tables, the combination of fields that tables can match on, metering configurations, OpenFlow group table configuration, and actions available to match and group tables such as adding or stripping packet headers and the modification of packet fields. The core features 56 and add-on features 58 are accessible via a run time API 60. Given the limited resources of the network switch 22 only a subset of all permutations of core features 56 and add-on features 58 are available at any one time. However, from time to time a user might require a different configuration requiring different combinations of core features 56 and add-on features 58 than those currently available in order to provide for a different functionality. For example, a particular network device configured for load balancing may be recommissioned as a firewall requiring a different configuration of core features 56 and add-on features 58. As modifying the configuration of core features 56 and add-on features 58 typically gives rise to a modification of the run time API 60, a modification in the manner in which the controller 24 accesses the features 56, 58 via the control channel 30 would typically also be required. In order to provide a fixed API 62 to the controller 24 for accessing one or other of the features 56, 58, a control library 64 is provided which translates control information 36 received from the controller 24 via the fixed API 62 into control understood by the run time API 60 a vice versa.

Still referring to FIG. 2A, in a particular embodiment the core features 56 and add-ons 58 are implemented in software and are recommissioned from time to time in response to changes in user requirements. An exemplary software environment comprises Programming Protocol-Independent Packet Processors (P4) which is a programming language optimized around network data forwarding. The language was originally described in a SIGCOMM CCR paper in 2014 entitled “Programming Protocol-Independent Packet Processors” and which is incorporated herein by reference in its entirety. An exemplary platform on which the network device 22 is implemented comprises a Tofino™ programmable switch comprising a Protocol Independent Switch Architecture (PISA).

Still referring to FIG. 2A, during recommissioning the control library 64 is linked to the recommissioned core features 56 and add-ons 58 using a configuration file 66. Typically, the control library 64 changes in unison with changes in the recommissioned core features 56 and add-ons 58, but the fixed API 62 remains unchanged. This allows the same controller 24 to connect to any recommissioned network device 22, irrespective of the changes made to the core features 56 and add-ons 58 during the recommissioning. The above approach supports the development of customized network devices 22 for each user which can be recommissioned from time to time for other or additional uses.

In a particular embodiment all flow tables 40 are based on upon a pre- processor template (not shown) which avoids otherwise replicating code for all possible permutations of a flow table 40. For each table specified in the configuration a code template is provided. A code template implements features available to each flow table. Since each flow table will typically have a different configuration, and a given flow table is unable to enable all features, the template creates a common mechanism by which the features are developed and then combined and distributed over multiple tables, as desired by the user. The code template includes the configuration file 66 and enables or disables a plurality of features. This is carried out as many times as there are flow tables defined in the configuration, and results in code being generated to implement each flow table, tailored to the configuration, while providing the same deterministic API as the fixed API 62. This can scale to as few or as many tables as desired.

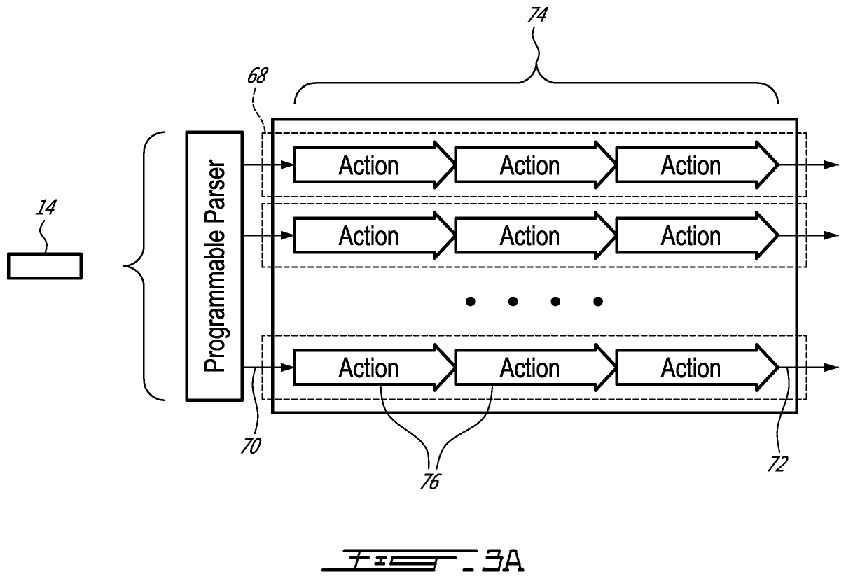

Referring now to FIG. 3A in addition to FIG. 2A, because a packet of data 14 arriving at the network device 22 can be typically handled independently from another packet of data 14, packet processing within the network device 22 is arranged as one or more pipelined flow entries 68 having a pipeline input 70 and pipeline output 72 and comprising one or more instructions (not shown) which are arranged in series and processed in sequence without interruption. In operation, the subset of required features 56, 58 selected for recommissioning a given network device 22 are processed in accordance with this pipelined flow entry 68.

Referring to FIG. 3B in addition to FIG. 3A, given the large number of permutations possible, and as the network device 22 comprises a finite amount of resources, not all desired permutations of sequences can typically be implemented on the network device 22. In order to address this, each pipelined flow entry 68 is divided into a plurality of actions 74 which in turn are analysed and combined into multiple action steps 76, where each action step 76 illustratively comprises one or more operations/actions to be applied to a data packet and which results in a defined step output 78. Each action step 76 may be subsequently resolved into a series of action chains 80 as required. For example, a flow entry 68 may be formed of one or more action steps 76. Each action step 76 may comprise one or more action chains 80, each action chain 80 comprising a plurality of actions 74 and where there is a dependency between the chains 80. For example, this could be the case where actions 74 which make up the chains 80 affect the same fields or where the ordering is different than that for which the pipeline was originally built.

Still referring to FIG. 3B, for example, a pipeline is illustratively programmed such that actions are processed in a predefined sequence. If the pipeline implements three actions A, B, C, then action A is executed first, followed by action B then action C. If a user wishes to execute action C first, then action B, and then action A, this can be achieved using the action chain technique wherein the packet is reparsed following action C, and reparsed following action B. Dependencies may also occur if the action step 76 changes the nature of the packet of data 14, such as through encapsulation. For example, a typical packet might comprise the following:

Ethernet A ->IP A ->TCP A ->payload

In a given implementation, one flow entry might include the action “Push L2GRE” which encapsulates the frame with additional headers and such that the resulting frame is, for example:

Ethernet B ->IP B ->GRE ->Ethernet A ->IP A ->TCP A ->payload

As the encapsulation serves to change the nature of the packet, in the event the flow entry includes an action to modify an Ethernet field after adding the encapsulation, the modification would still be applied to the Ethernet A field instead of the Ethernet B field. In order to apply the modification to the Ethernet B header, an action chain is applied to extend packet processing and the entire packet including the added headers reparsed again.

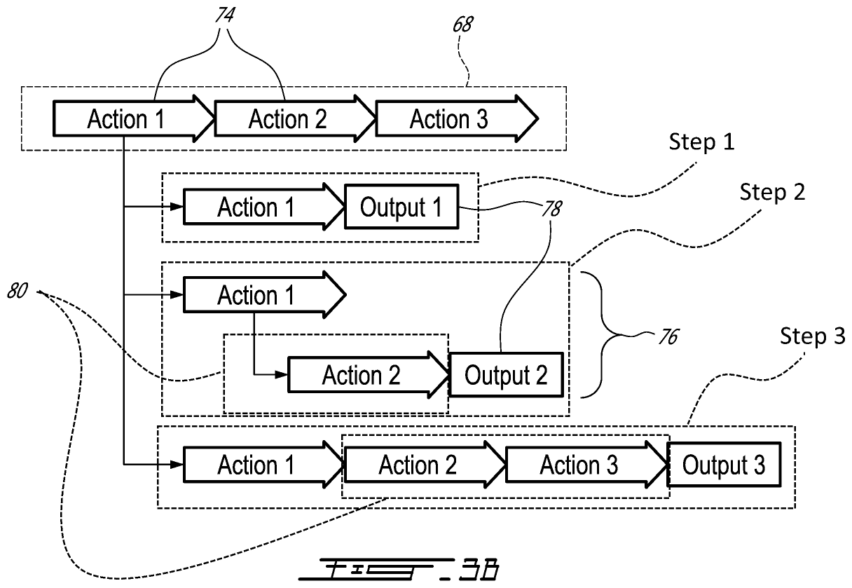

Referring to the flow chart 82 of FIG. 4 in addition to FIG. 3B, once the “tree” of action steps 76 and action chains 80 has been established a subsequent analysis can be carried out to identify areas of optimisation and reduce resource requirements through the reuse of the same actions 76/action chains 80 within different flow entries 68. The analysis illustratively commences with a decision 84 as to whether the flow entry 68 comprises a single or multiple action steps 76. In the event that the flow entry 68 is comprised of a single action step 76 a subsequent decision 86 determines if the flow entry 66 comprises a single action chain 80. If the flow entry 68 comprises a plurality of action chains 80 the action step is retained 88. If the flow entry 68 comprises a single action chain 80 the analysis continues with a decision 90 as to whether the action chains 80 generate a single output. In the affirmative the action step is deleted 92 and in the negative the action step is retained 88. In the event that the flow entry 68 comprises a plurality of action steps a decision 94 is made as to whether or not the plurality of action steps give rise to a single output. In the affirmative the action steps are deleted 96. In the negative a decision 98 is made as to whether the action steps of the flow entry 68 are identical. In the affirmative the action steps are combined 100. In the negative all the action steps are retained 102.

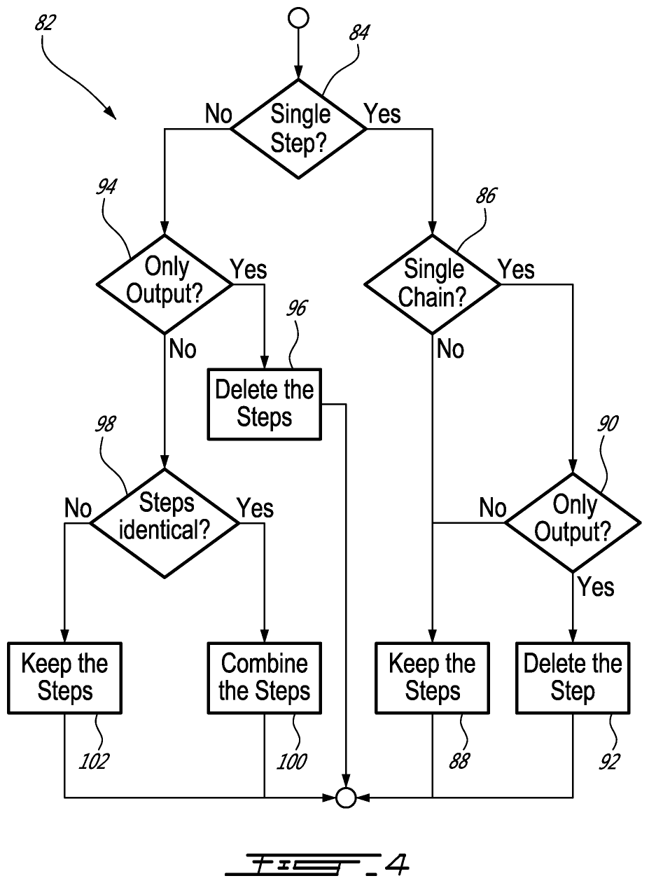

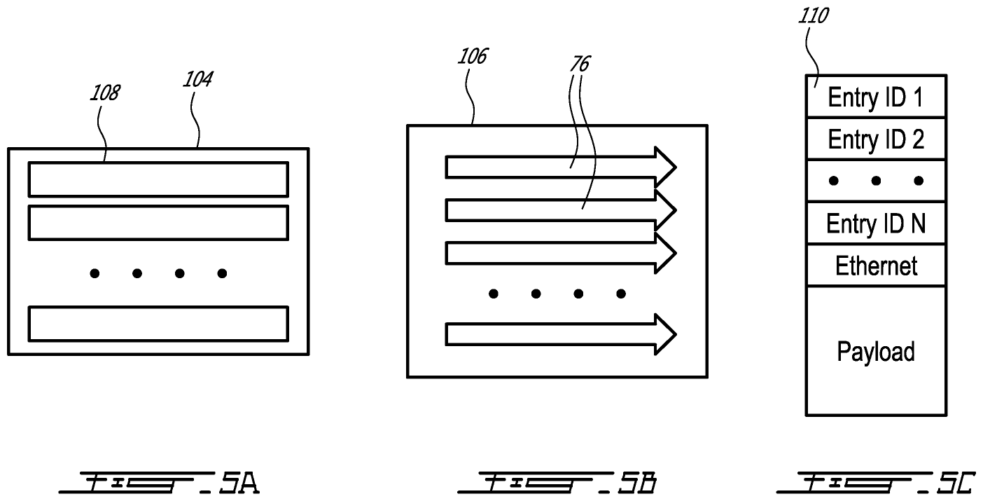

Referring now to FIGS. 5A, 5B and 5C, flow 68 entries are added to both a match table 104 and an action chain table 106. The match table entries 108 serve to identify which entry is matched by a given packet of data 14 and returns an identifier 110 together with one or more output ports. The action chain table 106 comprises all action steps 76. As illustrated in FIG. 5C, the entry identifier 110 is illustratively added to the packet of data 14, or frame, and such that if multiple match table entries 108 provide a match, the packet of data 14 accumulates all such match table entries 108 and such that all action steps 76 may be executed. The packet of data 14 is subsequently forwarded to the action chains table 106 via a unicast port or a multicast group to be processed in accordance with the accumulated match table entries 108 and action steps 76 in the action chains table 106. In this manner the flow table is split between an ingress pipeline part and an egress pipeline part, the ingress part of the pipeline identifying actions to apply to the packet of data 14 and the egress part executing the actions. Division of the flow table in this manner provides for improved scalability and the accommodation of an arbitrary number of flow tables, limited only by the resources available on the network device 22.

FIGS. 5A, 5B and 5C, in the case of a unicast forwarding the accumulated match table entries 108 are processed according to a First In First Out (FIFO) type order. In the case of multicast forwarding, the packet of data 14 is replicated together with a Replication ID (RID) value which allows the network device processing to identify the step identifier for each replica. The RID is a value that the fixed control API can provide for a particular replication operation associated with a match entry. After replicas have been generated, each replica is tagged with the RID such that a data plane application can determine what kind of multicast took place and fetch the right actions accordingly. For example, a multicast might comprise three (3) replicas where each replica has different actions and another multicast comprises three (3) replicas where each replica executes the same actions. The RID allows the replica to know whether to fetch shared actions or specific actions. RIDs comprise one of three (3) different values: (1) there are no steps only output; (2) only a single action step for all replicas, in which case the action step is the same for all replicas; and (3) a different action step for each replica in which case the action step corresponds to the egress port of the replica. This allows the right actions to be applied to the right packet of data 14. In a scenario where multiple packets of data 14 are generated from a single flow entry 68 the results can be complex, each with different sets of action chains 80. However, this is made possible through the use of the RID in combination with the egress port.

Still referring to FIGS. 5A, 5B and 5C, in order to provide for flexibility a user may choose the combinations of actions to perform on a packet of data 14. This is accommodated through the above described provision of execution in two stages. At a first stage the actions to be executed and with which parameters are identified which are illustratively written via an action into meta data. At a second stage the meta data is matched against a plurality of smaller tables and which on match execute each action step 76. The action step 76 is found by matching the ID of the match table entry 106 with an entry on the action chains table 106. Each action chain 80 may comprise a subsequent action chain 80, as identified before during the analysis of the actions 74 as carried out above. In this case the packet of data 14 is processed in accordance with the current action chain 80, the processed packet of data 14 illustratively cloned or copied and relayed towards the egress port and the packet of data 14 dropped. In a particular embodiment the cloned packet of data 14 comprises a chain ID which is incremented following completion of each action chain 80. The cloned packet of data 14 is subsequently de-parsed and reparsed and the action chain 80 continued until its end is reached. In this manner extended processing can be applied to a given packet.

Although the present invention has been described hereinabove by way of specific embodiments thereof, it can be modified, without departing from the spirit and nature of the subject invention as defined in the appended claims.

We claim:

1. A reprogrammable software defined network device for use with an external control application, the device comprising:
a standardized control API accessible by the external control application for accessing a plurality of switch features;
a programmable switch capable of implementing only a subset of said plurality of switch features;
a switch program for implementing said subset of said switch features on said programmable switch, each of said subset accessible via a runtime API; and
a control library interconnecting said standardized control API and said runtime API such that each of said subset is accessible by the external controller using said standardized control API via said runtime API;
wherein said subset changes from time to time in response user requirements and wherein a change in said subset gives rise to a change in said runtime API.

2. The network device of claim 1, wherein said plurality of switch features comprises a set of core features and a set of add on features and wherein said subset comprises said set of core features and selected ones of said add on features.

3. A method of providing via a standardized control API access to a selected subset of a plurality of possible features on a software defined network device comprising a programmable switch capable of implementing only the subset of the features at any one time, the method comprising:
recompiling a switch program to provide selected features from the plurality of features, wherein said selected features are accessible via a run time API; and
recompiling a control library interconnecting the standardized control API and said run time API such that said selected features are accessible via the standardized control API.

4. The method of claim 3, further comprising a configuration file and wherein said configuration file links said control API with said run time API.

5. The method of claim 3, wherein the features comprise core features further comprising a configuration file and wherein said configuration file links said control API with said run time API.

6. A method of recommissioning a software defined network device comprising a programmable switch capable of implementing only a subset of a plurality of possible features at any one time, comprising:
providing a standardized control API access to a first selected subset of a plurality of possible features on a software defined network device comprising a programmable switch capable of implementing only the subset of the features at any one time;
recompiling a switch program to provide selected features from the plurality of features, wherein said selected features are accessible via a run time API; and
recompiling a control library interconnecting the standardized control API and said run time API such that said selected features are accessible via the standardized control API.

7. A method for optimising a network device comprising a plurality of processing pipelines operating in parallel for processing respective streams of data packets, each pipeline comprising a respective pipeline flow entry, the method comprising: dividing each pipeline flow entry into a plurality of action steps each defining an ordered sequence of at least one action to be applied to the respective stream of data packets, each action step resulting in a step output;
resolving each action step into an ordered series of action chains, each action chain comprising a subsequence of at least two dependent ones of said actions; and
processing each data packet of according to said ordered series of action chains.

8. The method of claim 7, wherein each of said data packets comprises at least one data field and further wherein a first of said actions is considered dependent on a second of said actions when both of said actions modify a same one of said at least one data field.

9. A data communications system for interconnecting at least one client application with at least one server application, the system comprising:
a control application;
a plurality of reprogrammable software defined network (SDN) devices, one of said SDN devices connected to the at least one client application and a different one of said SDN devices connected to the at last one server application and wherein said SDN devices are interconnectable such that a data path and such that the at least one client application can communicate with a selected one of the at least one server application;
wherein each of said SDN devices comprises:
a standardized control API accessible by the external control application for accessing a plurality of switch features;
a programmable switch capable of implementing only a subset of said plurality of switch features;
a switch program for implementing said subset of said switch features on said programmable switch, each of said subset accessible via a runtime API; and
a control library interconnecting said standardized control API and said runtime API such that each of said subset is accessible by the external controller using said standardized control API via said runtime API;
wherein said subset changes from time to time in response user requirements and wherein a change in said subset gives rise to a change in said runtime API.

10. The network device of claim 9, wherein said plurality of switch features comprises a set of core features and a set of add on features and wherein said subset comprises said set of core features and selected ones of said add on features.

11. The data communications system of claim 10, wherein said set of core features are available in all of said SDN devices.
